(19) United States
(12) Patent Application Publication
(10) Pub. No.: US 2024/0375988 A1
(43) Pub. Date: Nov. 14, 2024

(54) BLANK MOULD BAFFLE PRESSING SYSTEM FOR FORMING A BURR-FREE MOUTH ENTRY OF A GLASS CONTAINER TO BE PRODUCED AND A METHOD OF PRODUCING A PARISON BY MEANS OF SAID SYSTEM

(71) Applicant: Gerresheimer Glas GmbH, Düsseldorf (DE)

(72) Inventors: Philipp AMRHEIN, Frammersbach (DE); Andreas KOHL, Lohr am Main (DE)

(21) Appl. No.: 18/683,799

(22) PCT Filed: Jul. 29, 2022
(86) PCT No.: PCT/DE2022/150001

§ 371 Date: Feb. 15, 2024

(30) Foreign Application Priority Data
Aug. 20, 2021 (DE) 10 2021 004 257.3

(51) Int. Cl. C03B 11/10; C03B 11/05; C03B 11/12

(52) U.S. Cl. CPC C03B 11/10; C03B 11/05; C03B 11/127; C03B 2215/50; C03B 2215/71

(57) ABSTRACT

A blank mould base pressing system (9) for forming a burr-free mouth entry for a glass container to be produced, which blank mould base pressing system comprises a piston (9.1) which is operated by charging with gas pressure, preferably with compressed air (18), and a pressing element (10) having a pressing-element profile (10.3), wherein the piston (9.1), when it is charged with gas pressure on one side, brings the blank mould base pressing system (9) into a pressing position in relation to a glass gob (1) which is in a blank mould (2) and is to be moulded and, on contact of the pressing-element profile (10.3) with the glass gob (1), forms a base for the glass container to be produced, wherein the blank mould base pressing system (9) has a means for controlling or regulating the stroke of the piston (9.1), wherein said stroke of the piston (9.1) serves to compensate for mass fluctuations of the glass gob (1), and a method for producing a parison (1.1) by means of the aforementioned blank mould base pressing system (9), wherein the blank mould base pressing system (9) has an internal cooling device for cooling by means of a cooling medium, and a method for producing a parison (1.1) by means of the blank mould base pressing system (9) according to the invention.

### CROSS-REFERENCE TO RELATED APPLICATIONS

This application is a National Stage application of International Patent Application No. PCT/DE2022/150001, filed Jul. 29, 2022, which claims priority to German Patent Application No. 10 2021 004 257.3, filed Aug. 20, 2021, the disclosure of each of which is incorporated herein by reference in its entirety.

### TECHNICAL FIELD

The present invention relates to a blank mould baffle pressing system for forming a burr-free mouth entry of a glass container to be produced and a method of producing a parison by means of said system.

### BACKGROUND OF THE INVENTION

In the case of blank mould base pressing systems, in particular in the narrow-neck pressing process for the cylindrical design of the inner mouth finish, burr formation frequently occurs at the mouth entry during production according to the state of the art.

For example, EP 0 327 240 A1 discloses a device (cf. FIG. 1) for a press-and-blow moulding process in so-called IS (individual section) glass moulding machines. Here, the working end position of the pressing plunger is determined by the deformation resistance of the molten glass in the blank mould when the blank mould cavity is completely filled with glass. It thus depends on the mass of the glass gob and/or the volume of the blank mould cavity. Due to the weight fluctuations of the glass gob, the working end position thus reaches different end positions in each case.

The design of the pressing plunger at its guide/bearing to the neckring is slightly conical to almost cylindrical. Towards the end of the pressing process, when the pressing plunger has almost reached its working end position, it is radially guided and centered by a guide ring which is not non-longitudinally divided. Due to the guide clearance or gap between the guide ring and the pressing plunger and the slight taper of the pressing plunger in this area, glass material can enter the gap in certain operating situations, the gap size being dependent on the respective working end position of the press plunger. This can unfavorably lead to sharp-edged mould seams, a so-called burr formation/wire edge, which can impair the sealing effect or assembly conditions between the glass container closure and the glass container, as well as damage closures or inserts that seal within the mouth entry and are thus pretensioned, and cause large vertical compression forces.

In another prior art device according to EP 1 129 039 BI, which attempts to avoid the afore-mentioned disadvantage according to the teachings of EP 0 327 240 A1, the neckring consists of a longitudinally divided neckring and a non-longitudinally divided guide ring held in a radial slot of the neckring, which is intended to guide the pressing plunger axially. The glass contact profile of the outer sealing edge of the mouth is integrated in the pressing plunger there and accordingly does not contain any mould partition between the pressing plunger and guide ring. The working end position of the pressing plunger is defined by the fact that an upper annular surface of the pressing plunger comes into contact with an annular mating surface of the mouth tool.

In this way, the disadvantage of EP 0 327 240 A1 with its end position of the pressing plunger dependent on the mass of the glass gob and the resulting problem of burr formation in the inner mouth area of the parison (and later glass container) is avoided, but at the price of a lack of mass compensation for the mass fluctuations of the glass gob, which in turn can lead to quality problems with regard to the formation of the blank mould baffle seam, for example if the glass mass squeezes too much into the gap between the parison and the blank mould wall in the region of the parison base, i.e. the later glass container base, as a result of an excessively large, high-mass glass gob, and then forms an excessively pronounced seam there which can no longer be formed into a glass container base of sufficient quality in the final molding. This can happen according to the teachings of EP 1 129 039 B1, since there the pressure with which the piston, which drives the pressing element for preforming the base into the glass material, can only be applied or not applied, but not adjusted with regard to its magnitude (cf. valves in FIGS. 7 and 8 together with respective description), and the pressing element there thus always moves with this predetermined pressure against the glass gob in the blank mould. If this pressure is too high when the mass of the glass gob is too large, the incompressibility of the liquid glass can lead to the aforementioned excessive intrusion of the glass into the gap between the parison and the blank mould wall in the area of the parison base, since the glass mass can no longer move downward against the tightly fitting plunger, nor should it.

EP 1 129 039 B1 attempts to overcome this problem by measuring the lowest piston position of the pressing element that is finally reached by means of a potentiometer, in order to then use this for adjusting the mass of the glass gob via the stroke of the plunger on the feeder (cf. EP 1 129 039 B1, para. [0038]).

However, such a procedure can naturally at most compensate the next glass gob in terms of its mass, but not the one currently used for production, which has already suffered the quality defect possibly caused by this at the base of the parison or later glass container.

It is also a disadvantage of EP 1 129 039 BI that heating and volume expansion take place there at the pressing element—for example caused by the preferred relatively long contact of the pressing element with the warm glass material there (cf. there in particular claim 2). This results in uncontrolled clearance between the pressing element and the blank mould due to longitudinal thermal expansion, which also boosts burr formation of the blank mould base. Also, due to the fact that the thermal expansion can cause the guide diameter on the pressing element to be larger than the guide diameter in the blank mould, jamming or tilting of the pressing element and blank mould may occur, resulting in considerable process disturbances, which is intolerable.

DE 32 32 288 C1 attempts to use an additional volume which is fixed at the beginning of the forming process to compensate for mass fluctuations and also uses compressed air control to reduce the thermal load on the piston. The piston stroke itself, however, is fixed here just like the additional volume already mentioned and is only influenced by the operating cycle.

To reduce the thermal load—in this case on the piston-EP 0 197 427 A1 uses cooling air directed through ducts, but mass compensation is not provided here.

DE 20 10 443 A1 attempts to achieve mass compensation by means of a purely mechanical device in the form of a spring-loaded blank mould baffle on the side opposite the press plunger. However, the press plunger itself operates here with a fixed clearance, namely always up to a certain height. In addition, the spring-loaded blank mould baffle is only able to achieve mass compensation in a very limited manner by means of a fixed maximum set by a pin.

In view of the aforementioned prior art, it is therefore the problem of the present invention, starting from EP 1 129 039 B1, to avoid burr formation between the pressing plunger and the guide ring inside the mouth entry and, at the same time, to ensure the quality of the glass containers to be produced by avoiding excessive burr formation of the base seam of the blank mould and preventing jamming or tilting of the press element and the blank mould during production.

### SUMMARY

This problem is solved according to the present invention by a blank mould base pressing system according to claim 1 and a method for producing a parison by means of such a blank mould base pressing system according to claim 11. Preferred embodiments derive from claims 2 to 9 and 11 to 14.

The blank mould baffle pressing system according to the present invention for forming a burr-free mouth entry for a glass container to be produced has-similar to the state of the art according to EP 1 129 039 B1-a piston operated by applying gas pressure, preferably compressed air, as well as a pressing element with a pressing element profile, whereby the piston, when pressurized with gas on one side, brings the blank mould baffle pressing system into pressing position against a glass gob to be shaped in a blank mould and in doing so preforms a base for the glass container to be produced by contacting the pressing element profile with the glass gob. However, the present invention differs from the state of the art according to EP 1 129 039 B1 in that it provides a control or closed-loop-control of the piston stroke, which serves to compensate for mass fluctuations of the glass gob, by adapting this stroke to the respective glass gob mass.

Such an adjustment of the stroke of the piston can preferably be carried out, for example, by means of a gas pressure sensor, which measures the gas pressure currently applied to the piston. Indeed, if a gob of more mass falls into the blank mould, the volume of the glass mass there is also greater and the piston reaches the gob sooner, whereupon the gas pressure of the piston due to the essentially incompressible liquid glass mass quickly increases as soon as the pressing element comes into contact with the glass mass. If one now measures this pressure, preferably using a gas pressure sensor, this ultimately determines the necessary stroke until the gob is reached, and then a further piston stroke can be stopped or slowed in time before there is too much intrusion of the glass material into the gap between the parison and blank mould profile in the area of the parison base. In this way, for example, a compensation of mass fluctuations of the glass gob can be achieved via the piston stroke, specifically for the currently manufactured parison.

However, this is by no means the only way to realize the compensation of mass fluctuations of the glass gob via the piston stroke. For example, it is also possible to measure up to what height the glass gob placed into the blank mould fills the blank mould, which can be done, for example, by means of a non-contact sensor, such as an optical sensor (e.g., a laser sensor) that uses triangulation measurement or time-of-flight measurement, or a 3D stereo imaging sensor. In this way, as a result of the measurement of the fill height of the blank mould with glass material, the path that the piston of the blank mould baffle pressing system needs to travel to bring the pressing element into contact with the glass material for preforming the base is also determined. A path measuring system can then be provided on the piston, which allows the pressing element to be moved according to the actual fill height of the blank mould with glass material and thus adapted to the current glass mass via the piston stroke, thereby compensating for mass fluctuations of the glass gob via the piston stroke.

Furthermore, systems can also be provided that determine the actual mass of the glass gob falling into the blank mould, for example by capturing its spatial extent (and specific weight) using an image capture system, and from this determine the necessary piston stroke path. Ultimately, therefore, there are a multitude of technical possibilities that allow for compensation of mass fluctuations of the glass gob via the piston stroke.

Also, the blank mould baffle pressing system according to the present invention for forming a burr-free mouth entry for a glass container to be produced has an internal cooling device for cooling by means of a cooling medium, which can avoid the possible disadvantage according to the state of the art after EP 1 129 039 B1 of heating and volume expansion at the pressing element due to prolonged contact with the warm glass material (see above), and thus jamming or tilting of the pressing element and blank mould and thus significant process disturbances can no longer occur. Accordingly, the method for producing a parison is also designed in such a way that during the production of the parison, cooling is carried out using the internal cooling de-vice of the blank mould baffle pressing system according to the present invention with a cooling medium, preferably compressed air.

The cooling medium is preferably distributed specifically to the inner surfaces of the pressing element by suitable means for this purpose, such as a cooling medium supply line in the piston for settle blow air (compressed air) of a glass machine and/or a cooling pipe arranged in the piston.

Particularly preferably, the cooling medium is separated from the working area of the piston by a seal-such as a sealing package-fitted at the cooling medium supply line.

Now, if one operates a method for producing a parison using this blank mould baffle pressing system according to the present invention, in which
a) a glass gob from a feeder is loaded into a blank mould from above, and
b) a plunger tool is positioned in a loading position as a falling limit for loading the glass gob at the lower end of the blank mould, and
c) the blank mould baffle pressing system performs a vertical closing movement by being moved from above into the blank mould until a stop on the blank mould baffle pressing system reaches a stop surface on the blank mould, whereby the piston is initially not subjected to gas pressure, but then shortly before or when reaching the stop surface is subjected to gas pressure and is thus pressed down to the stop surface, whereby the pressing element is in pressing position, and compensation for mass fluctuations of the glass gob is achieved by controlling or closed-loop-controlling the piston stroke, and
d) during the vertical closing movement of the blank mould baffle pressing system, the plunger tool is furthermore pressed against the parison forming in the blank mould up-wards against the pressing element in pressing position, until the plunger tool with its plunger surface stops against a guide ring surface, against which it is pressed until the pressing process is completed,

and whereby the blank mould baffle pressing system is cooled during the production of the parison by means of an internal cooling device of the blank mould baffle pressing system with a cooling medium, preferably compressed air,

not only can a significant reduction in the formation of burrs at the base of the blank mould be achieved due to the mass compensation, which thus enables the quality of the glass container to be produced subsequent to the parison formation with regard to the burr formation of the blank mould baffle seam to be guaranteed, but also due to the pressing of the plunger tool with its plunger surface against the guide ring surface during the vertical closing movement of the blank mould baffle pressing system, it can also be ensured that a burr formation between the pressing plunger and the guide ring within the mouth entry is avoided. Likewise, the internal cooling with a cooling medium counteracts a jamming or tilting of the pressing element and blank mould.

It goes without saying that after the pressing process according to the present invention, a demoulding takes place, whereby the plunger tool is driven out vertically downwards and the blank mould baffle pressing system is driven out vertically upwards and the blank mould is opened, whereupon a transfer to a final forming station for forming the glass container from the preformed parison can take place.

The pressing element profile of the pressing element of the blank mould baffle pressing system according to the present invention preferably has a convex geometry curved towards the glass gob, which advantageously reduces the pressing pressure applied in the parison by the pressing element.

Also, the pressing element can preferably be attached to the piston by means of a detachable connection, which allows easy replacement. Here, a thread can preferably serve as a detachable connection. However, other detachable connections, such as bayonet locks, are also possible.

In a further preferred embodiment of the blank mould baffle pressing system according to the present invention, this system has-preferably integrated into the blank mould base pressing system according to the present invention-springs that press the pressing element upwards against a-preferably integrated-stop surface and thus hold it in loading position as long as the piston is not subjected to gas pressure. Such an embodiment according to the present invention is also advantageous because the springs support the aforementioned mass compensation of the glass gob over the piston stroke, since they are able to dampen the pressure of the pressing element on the glass material and ensure that the pressing element does not come into contact with the glass twice, which would negatively affect the quality of the parison formation, and thus provide a little more reaction time for a control or closed-loop-control of the piston stroke path used for adaptation to the mass of the glass gob, which facilitates the control and/or closed-loop-control of the process.

In a further particularly preferred embodiment of the blank mould baffle pressing system according to the present invention, this comprises a slide bearing and/or a funnel guide mounted at the top of the blank mould, which guide the piston with pressing element axially to the blank mould profile before the pressing element immerses into the blank mould profile, which can effectively counteract a tilting of the pressing element edge with the blank mould profile.

### BRIEF DESCRIPTION OF THE DRAWINGS

In the following, the state of the art as well as non-limiting embodiments of the present invention will be discussed with reference to the drawings wherein:

FIG. 1 shows an overview of the process according to the present invention step by step in a schematic representation of individual production steps in rows from top to bottom and in each case from left to right,

FIG. 2 shows the loading of the blank mould with a glass gob as part of the method according to the present invention,

FIG. 3 shows the plunger tool according to the present invention serving as a falling limit for the loading of the glass gob,

FIG. 4 shows the beginning of a vertical closing movement of the blank mould baffle pressing system according to the present invention,

FIG. 5 shows the further closing movement of the blank mould baffle pressing system and the pressing process of the plunger tool against the parison forming in the blank mould upwards according to the present invention,

FIG. 6A shows a preferred embodiment according to the present invention with a preferably provided integrated internal cooling of the pressing element of the blank mould baffle pressing system and its operation according to the method of the present invention,

FIG. 6B shows the result of a flow analysis, which confirms the forced convection at the pressing element in the embodiment according to the present invention with integrated internal cooling of the pressing element according to FIG. 6A,

FIG. 6C shows an embodiment according to the present invention in which ventilation slots are attached to the pressing element of the blank mould baffle pressing system,

FIG. 7 illustrates once again the effects of the present invention, particularly with regard to the prevention of burr formation between the pressing plunger and guide ring within the mouth entry, but also the assurance of the quality of the glass containers to be produced with regard to the burr formation of the blank mould baffle seam,

FIG. 8 shows the demoulding after the end of the pressing process,

FIG. 9 shows a transfer of the parison formed according to the present invention to a final forming station,

FIGS. 10A and 10B show the problem of sharp-edged mold seams on the parison, and

FIG. 10C shows a changed position of the burr in the area of the mouth entry.

### DESCRIPTION OF THE PREFERRED EMBODIMENTS

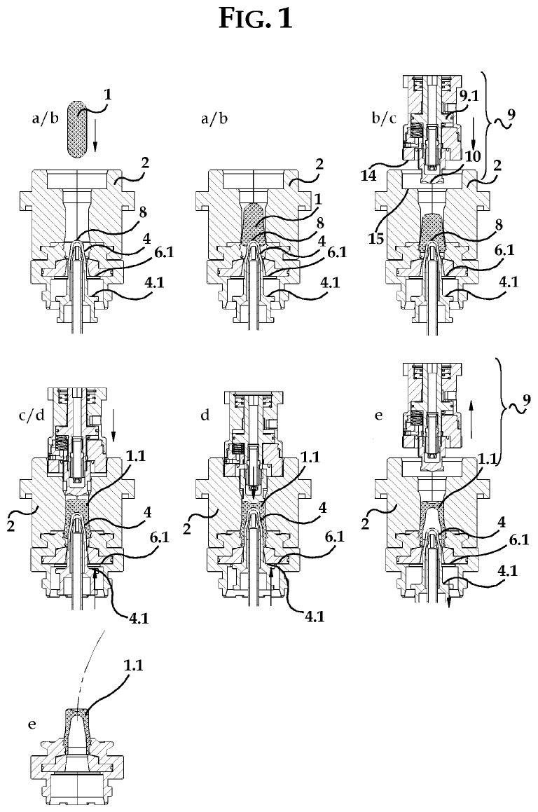

FIG. 1 in a step-by-step, schematically arranged presentation of individual manufacturing steps, gives an overview of the method according to the present invention for the production of a parison using a blank mould baffle pressing system 9 according to the present invention. Here,
a) a glass gob 1 is charged from a feeder into a blank mould 2 from above, and
b) a plunger tool 4 is positioned in a loading position 8 as a falling limit for the loading of the glass gob 1 at the lower end of the blank mould 2.
c) The blank mould baffle pressing system 9 performs a vertical closing movement by being moved from above into the blank mould 2 until a stop 14 on the blank mould baffle pressing system 9 reaches a stop surface 15 on the blank mould 2, whereby the piston 9.1 is initially not not subjected to gas pressure, but then shortly before or when reaching the stop surface 15 is subjected to gas pressure and is thus pressed down to the stop surface 15, whereby the pressing element 10 is in pressing position, with a compensation of mass fluctuations of the glass gob 1 being performed via a control or closed-loop-control of the piston stroke of the piston 9.1.
d) During the vertical closing movement of the blank mould baffle pressing system 9, the plunger tool 4 is pressed against the parison 1.1 forming in the blank mould 2 upwards and furthermore against the pressing element 10 which is in the pressing position, until the plunger tool 4 with its plunger surface 4.1 rests against a guide ring surface 6.1, against which it remains pressed until the end of the pressing process.
e) After the pressing process is finished, a demolding takes place, whereby the plunger tool 4 is driven out vertically downwards and the blank mould baffle pressing system 9 is driven out vertically upwards and the blank mould 2 is opened, after which a transfer to a final forming station can take place for forming a glass container from the parison, whereby in the illustration to be seen here in the last row on the far left, the transfer to the final forming station is visible by the arc seen there, which indicates the pivoting of the parison.

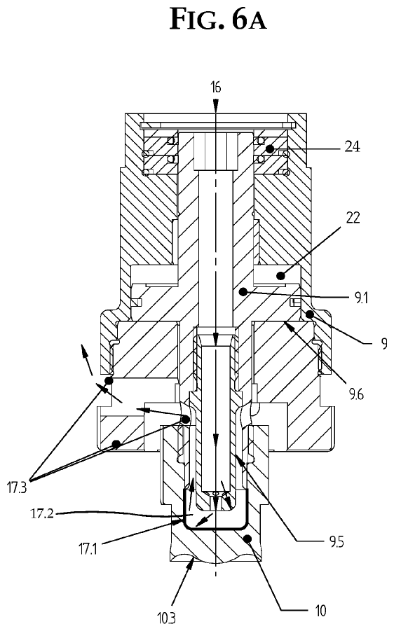

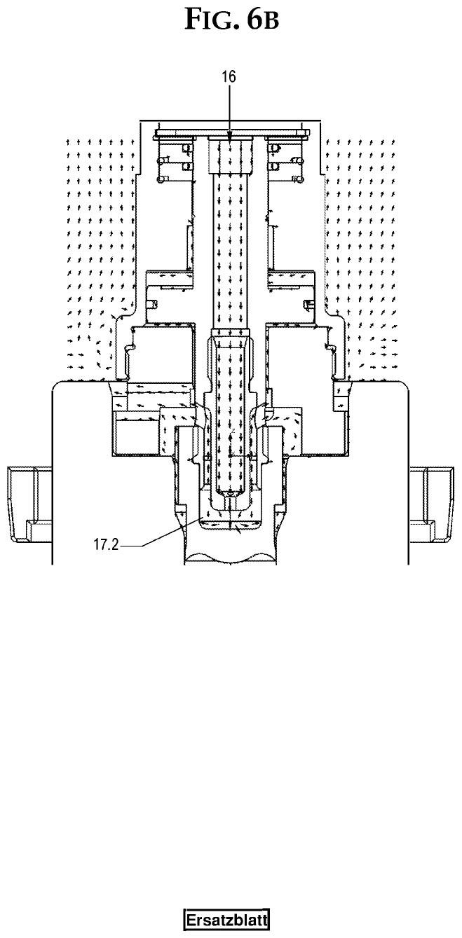

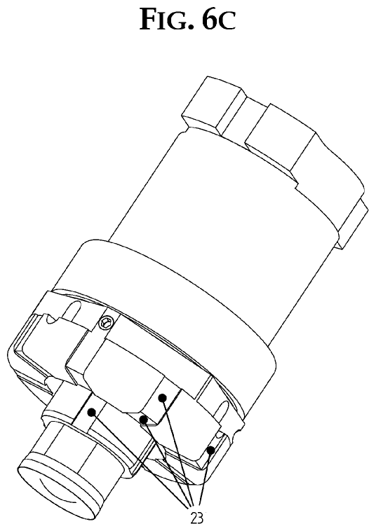

During the production of the parison 1.1, cooling is provided by means of an internal cooling device (see especially also FIGS. 6A, 6B, and 6C) of the blank mould baffle pressing system 9 with a cooling medium, preferably compressed air. In this way, jamming or tilting between the pressing element 10 and blank mould profile 11 is counteracted (see also the explanations on FIGS. 6A, 6B, and 6C as well as the figures themselves), which has a very positive effect on process stability.

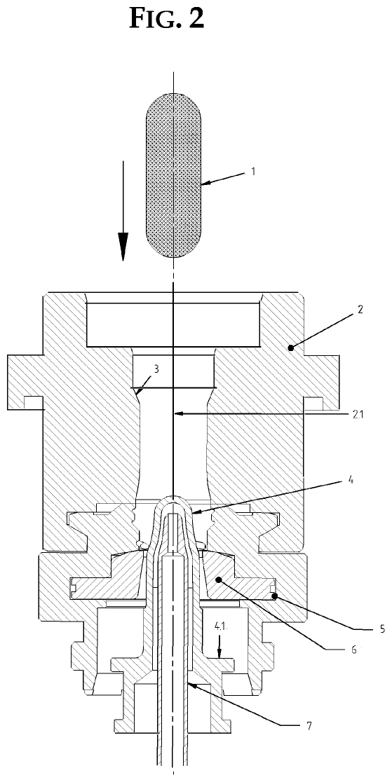

FIG. 2 shows the loading of the blank mould 2 with a glass gob 1 as part of the method according to the present invention. Here it is shown how a glass gob 1 is charged from a distribution device (feeder) from above into a blank mould 2, which has a longitudinally mould partition. The glass gob 1 is guided axially 2.1 during the vertical free fall at a funnel opening 3 attached in the upper part of the blank mould 2. At the bottom of the illustration is a plunger tool 4 with an integrated cooling tube 7, a neckring 5, and a guide ring 6 which is guided radially and axially 2.1 in the neckring 5.

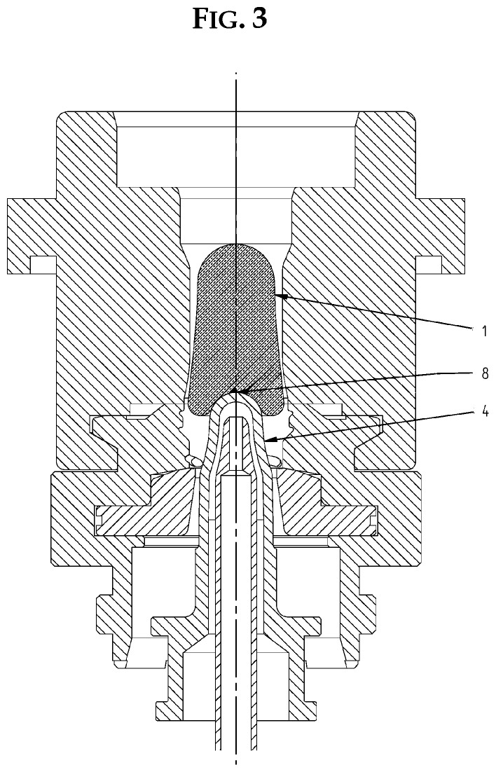

FIG. 3 shows how the plunger tool 4 serves as a falling limit for the loading of the glass gob 1 according to the present invention. The plunger tool 4 is positioned here in so-called loading position 8 and serves there as a falling limit for the loading of the glass gob 1.

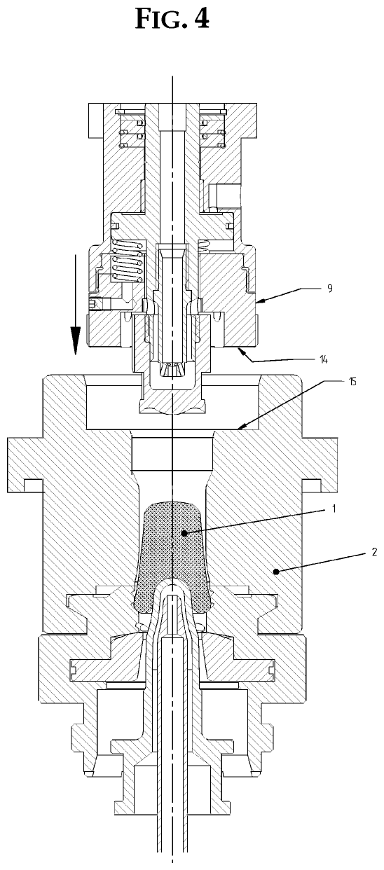

FIG. 4 shows the beginning of a vertical closing movement of the blank mould baffle pressing system 9 according to the present invention. As soon as the glass gob 1 is charged into the blank mould 2, the blank mould baffle pressing system 9 closes the blank mould 2 at its upper end by means of vertical movement from top to bottom.

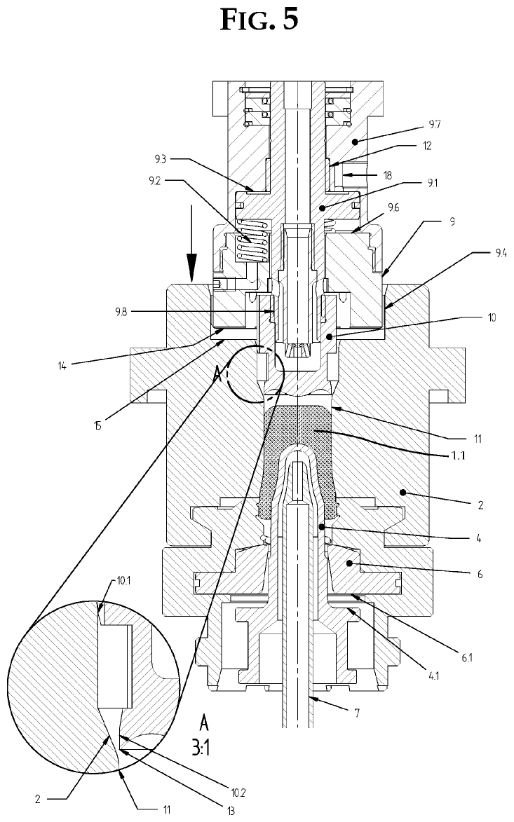

FIG. 5 shows the further closing movement of the blank mould baffle pressing system 9 and the simultaneous pressing process of the plunger tool 4 against the parison 1.1 forming in the blank mould upwards according to the present invention.

During the vertical closing movement, the blank mould baffle pressing system 9 is aligned and guided axially from the blank mould 2 by means of a diameter guide 9.4. Here, the piston 9.1 is not pressurized with compressed air 18 and is pressed vertically upwards against an integrated stop surface 9.3 by means of springs 9.2. A pressing element 10, which serves for the preforming of the base, is thus in the loading position. With further vertical closing movement of the blank mould baffle pressing system 9, the pressing element 10 is first axially aligned at an upper funnel guide 10.1. This occurs before the lower guide diameter 10.2 on the pressing element 10 enters the blank mould profile 11. This and a slide bearing 12, which is arranged in the blank mould baffle pressing system 9, ensures that the pressing element 10 is axially aligned with the blank mould 2 before entering the blank mould profile 11, which has a very advantageous effect on process stability, as this counteracts the tilting of the pressing element edge 13 with the blank mould profile 11. The vertical closing movement of the blank mould baffle pressing system 9 is finished as soon as the stop 14 on the blank mould baffle pressing system 9 reaches the stop surface 15 on the blank mould 2. Preferably shortly before reaching the stop surface 15, the piston 9.1 is pressed downwards onto the stop surface 9.6 by means of compressed air 18 against the springs 9.2. The pressing element 10 is now in the pressing position.

During the vertical closing movement of the blank mould baffle pressing system 9, the plunger tool 4 is pressed against the parison 1.1 forming in the blank mould 2 upwards against the pressing element 10, which is in the pressing position (see above). The movements and cooling possibilities of the plunger tool 4 and its integrated cooling tube 7 are preferably carried out in a known manner by the corresponding IS machine elements and mechanisms.

The movement of the plunger tool 4 ends as soon as its plunger surface 4.1 rests on the cover ring surface 6.1. The plunger tool 4 is pressed against the cover ring 6 until the pressing process is completed.

FIG. 6A illustrates the integrated internal cooling of the pressing element 10 of the blank mould baffle pressing system 9 as proposed by the present invention, as well as its operation according to the method according to the present invention.

In this embodiment, the blank mould baffle pressing system 9 according to the present invention features an integrated internal cooling of the pressing element 10. A pressure air source commonly used in IS glass machines for the so-called settle blowing is used. This compressed air is supplied via a cooling medium supply line 16 and used to cool the pressing element 10. The compressed air, serving as a cooling medium here, is directed to the inner surfaces 17.1 of the pressing element 10 through a cooling tube 9.5 integrated into the piston 9.1. Forced convection in the area 17.2 between the cooling medium (e.g., compressed air-see above—as cooling air or fluid) and the inner surfaces 17.1 of the press element 10 cools it and stabilizes its solid state temperature. The cooling medium is preferably separated from the working area 22 of the piston 9.1 by a sealing package 24 inserted at the cooling medium supply line 16.

FIG. 6B shows the result of a flow analysis, illustrating the forced convection at the pressing element in the embodiment according to the present invention with integrated internal cooling of the pressing element as shown in FIG. 6A. The flow course is shown. The heated cooling medium, preferably the cooling air, which is supplied via the cooling medium supply line 16, escapes through a venting system 17.3 integrated into the blank mould baffle pressing system 9 (also see FIG. 6A). This allows the control of the thermal expansion of the pressing element guides (see FIG. 5) 10.1, 10.2, counteracting the disadvantage of heating and volume expansion at the pressing element due to a relatively long contact with the warm glass material in certain embodiments (see the prior art according to EP 1 129 039 B1, claim 2).

This may prevent jamming between the pressing element 10 and the blank mould profile 11, which has a very positive effect on process stability.

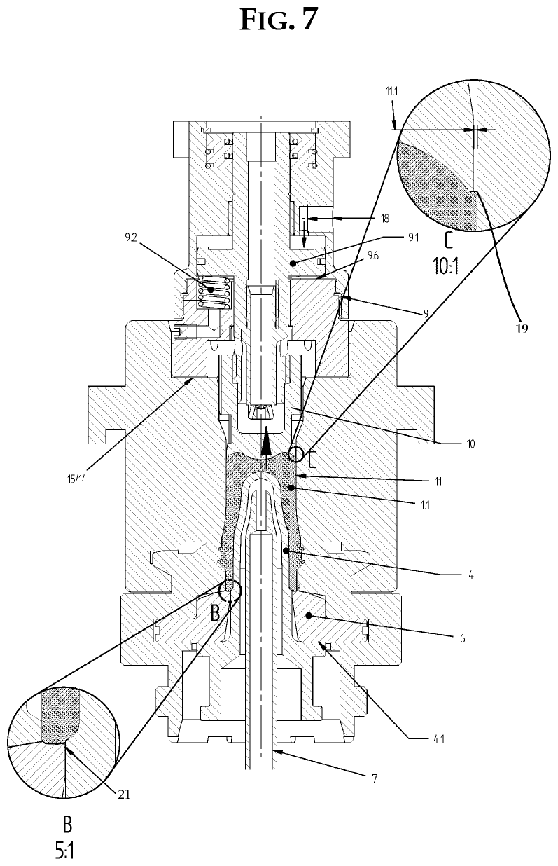

Also, the cooling leads to a reduction of the clearance (see also FIG. 7) 11.1 between the pressing element 10 and the blank mould profile 11, which counteracts the formation of an undesirably strongly pronounced blank mould baffle seam 19.

FIG. 6C shows an embodiment according to the present invention in which ventilation slots 23 are arranged on the pressing element of the blank mould baffle pressing system, ensuring the venting of the medium, preferably air, that must escape due to displacement during the pressing process. Ventilation slots are also preferably arranged on the guide part.

FIG. 7 further illustrates the effects of the present invention, particularly in terms of avoiding burr formation between the plunger tool 4 and the guide ring within the mouth entry, and ensuring the quality of the glass containers to be manufactured with respect to an undesired formation of the blank mould baffle seam.

Compensation for possible mass or weight fluctuations of the glass gob 1 is achieved through the stroke of the piston 9.1. As mentioned before, this can be technically realized in several ways, preferably by measuring and evaluating the pressure applied to the piston. The piston 9.1 is displaced by the pressure in the parison 1.1 against the pressure force acting on the piston 9.1.

This force effect completes the pressing of the parison 1.1.

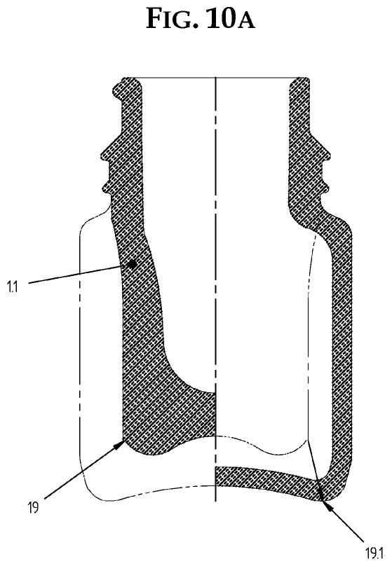

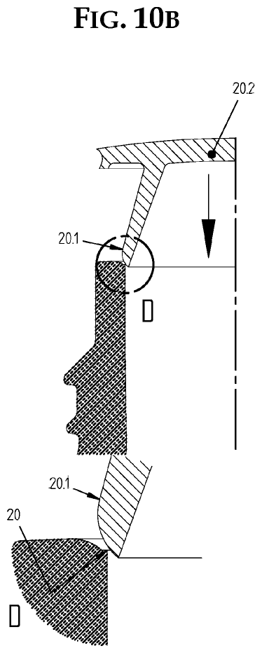

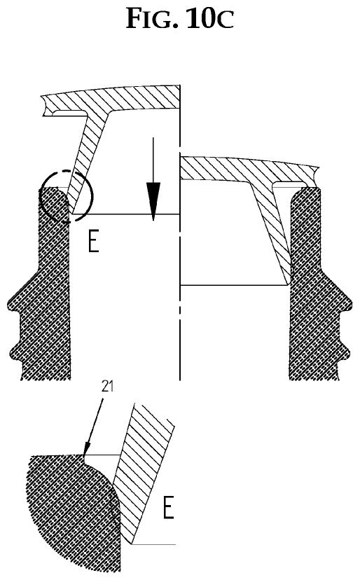

The mass or weight compensation counteracts the intrusion of glass material into the gap 11.1 between the pressing element 10 and the blank mould profile 11, helping to avoid the formation of an undesired burr 19 at the blank mould baffle (see also FIG. 10A) and thus ensuring the quality of the glass container to be produced in this area.

The mass or weight compensation in the blank mould baffle pressing system 9 ensures that, due to the limitation on the guide ring 6, the plunger tool 4 always reaches the same working end position, regardless of the mass or weight of the glass gob 1 or parison 1.1 and the volume of the blank mould profile 11. This also makes it possible to change the position of the burr between the plunger tool 4 and the guide ring 6 to an area outside the mouth entry. The resulting new position of the—then no longer disturbing-burr 21 outside the mouth entry in the area of the mouth can be seen not only here, but also in FIG. 10C. Due to this effect of the present invention, the assembly friendliness and the sealing effect of inner-sealing closures significantly improve, as this change eliminates the risk of closure abrasion caused by a burr forming in the area of the mouth. The pressing force or the friction of the closure when introducing the closures into the glass containers is thus considerably reduced.

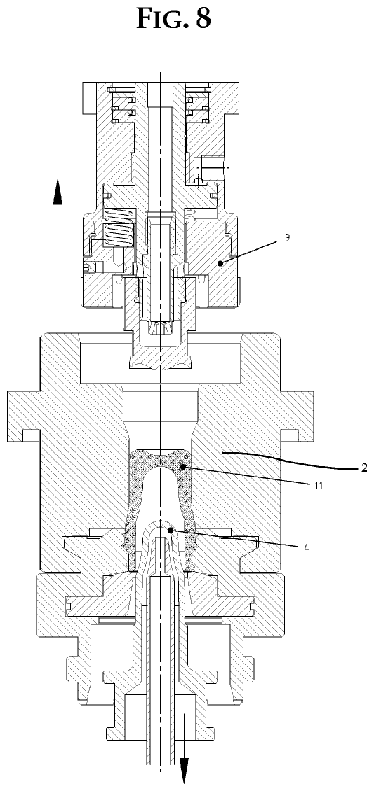

FIG. 8 shows the demoulding after the completion of the pressing process, where the plunger tool 4 moves vertically downwards out of the parison 1.1 and the blank mould 2, and the blank mould baffle pressing system 9 is driven out vertically upwards, and the blank mould 2 is opened.

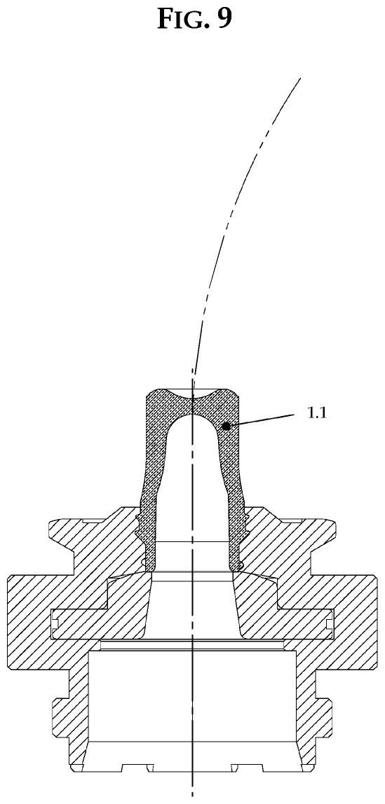

FIG. 9 finally shows a transfer of the parison 1.1 formed according to the present invention to a final forming station, where the upward rightward arch in the figure here indicates a corresponding pivotal movement of the parison 1.1.

FIG. 10A and FIG. 10B show the problem of sharp-edged form seams on the parison.

As already mentioned in the introduction, it is according to the prior art corresponding to EP 0 327 240 A1, which shows a device (see there FIG. 1) for a press-blow process in so-called IS (Individual Section) glass forming machines, that sharp-edged form seams can form on the parison. According to EP 0 327 240 A1, the working end position of the pressing plunger is determined by the resulting resistance between the pressing plunger and the parison formed in the blank mould (i.e., the glass pressed against the blank mould and neckring) and is thus dependent on the volume of the blank mould cavity and/or the mass or weight of the glass gob. Due to the mass fluctuations of the glass gob, the working end position of the pressing plunger, which is slightly conical to almost cylindrical towards the neckring, thus reaches different end positions each time.

Towards the end of the pressing process, when the pressing plunger has almost reached its working end position-(which, with a fixed volume of the blank mould cavity, is dependent on the mass of the glass gob)—it is radially guided and centred by a non-divided guide ring.

Due to the guiding clearance or gap between the guide ring and the pressing plunger, and the slight conicity of the pressing plunger in this area, glass material can enter the gap in certain operating situations, the gap size being dependent on the respective working end position of the pressing plunger, which in turn depends on the mass of the glass gob (see above).

As already mentioned, the glass pressed against the blank mould and neckring is referred to as parison 1.1. The position of the gap and thus the glass seam 20 is positioned directly at the parison entry and in the method according to EP 0 327 240 A1 on the conical almost cylindrical guiding part of the pressing plunger because of the weight compensation realized over the pressing plunger resistance, which is needed to compensate for the mass fluctuations of the glass gob, it is also unavoidable.

The sharp-edged glass seams or burr formations that can result from this in unfavorable cases can impair the sealing effect or assembly conditions between a glass container closure 20.2 and the glass container and can damage inner-sealing and thus pre-stressed closures or inserts 20.1 within the mouth entry, causing large vertical pressing forces. This represents a disadvantage of this method according to EP 0 327 240 A1.

FIG. 10C shows a changed position of the burr in the area of the mouth entry, achieved by the present invention, which avoids the disadvantages mentioned above with reference to FIGS. 10A and 10B. It ensures that the plunger tool remains pressed against the guide ring 6 during the pressing process until its end, thus avoiding the disturbing burr 20 (see above) that forms according to the prior art between the pressing plunger and the guide ring, since at most a non-disturbing burr 21 may now form outside the mouth entrance.

At the same time, the present invention ensures the formation of a blank mould baffle with a burr 19 (see the left half of the illustration in FIG. 10A) which is significantly reduced compared to the prior art-if it still exists at all—and can thus be blown downwards onto the bottom of the container in a rounding to position 19.1 in the subsequent final forming (see the right half of the illustration in FIG. 10A), thereby also ensuring a high quality of the base of the glass container to be produced.

Although various embodiments of the present invention have been described and shown, the invention is not restricted thereto, but may also be embodied in other ways within the scope of the subject-matter defined in the following claims.

What is claimed is:

1. A blank mould baffle pressing system for forming a burr-free mouth entry of a glass container to be produced, which comprises a piston operated by the supply of gas pressure, preferably compressed air, and a pressing element with a pressing element profile, whereby the piston, when subjected with gas pressure on one side, brings the blank mould baffle pressing system into a pressing position against a glass gob to be formed in a blank mould, and preforms a baffle for the glass container to be produced in the process of contact of the pressing element profile with the glass gob, wherein the blank mould baffle pressing system comprises a control or closed-loop-control of the stroke of the piston, which serves to compensate for mass fluctuations of the glass gob by adapting this stroke to the respective glass gob mass, the blank mould baffle pressing system having an internal cooling device for cooling by means of a cooling medium.

2. The blank mould baffle pressing system for forming a burr-free mouth entry of a glass container to be produced according to claim 1, wherein the internal cooling device for cooling has a means that specifically distributes the cooling medium on the inner surfaces of the pressing element.

3. The blank mould baffle pressing system for forming a burr-free mouth entry of a glass container to be produced according to claim 1, wherein the means for targeted distribution of the cooling medium on the inner surfaces of the pressing element has a cooling medium supply line for air for settle blowing of a glass machine as compressed air for cooling in the piston.

4. The blank mould baffle pressing system for forming a burr-free mouth entry of a glass container to be produced according to claim 1, wherein the means for targeted distribution of the cooling medium on the inner surfaces of the pressing element has a cooling tube arranged in the piston.

5. The blank mould baffle pressing system for forming a burr-free mouth entry of a glass container to be produced according to claim 3, wherein the cooling medium is separated from the working area of the piston by a seal package inserted at the cooling medium supply line.

6. The blank mould baffle pressing system for forming a burr-free mouth entry of a glass container to be produced according to claim 1, wherein the pressing element profile has a convex or concave geometry curved towards the glass gob.

7. The blank mould baffle pressing system for forming a burr-free mouth entry of a glass container to be produced according to claim 1, wherein the pressing element is attached to the piston by means of a detachable connection.

8. The blank mould baffle pressing system for forming a burr-free mouth entry of a glass container to be produced according to claim 7, wherein a thread serves as the detachable connection.

9. The blank mould baffle pressing system for forming a burr-free mouth entry of a glass container to be produced according to claim 1, wherein the blank mould baffle pressing system comprises springs which press the pressing element upwards against a preferably integrated stop surface and thus keep it in the loading position as long as the piston is not subjected with gas pressure.

10. The blank mould baffle pressing system for forming a burr-free mouth entry of a glass container to be produced according to claim 1, wherein the blank mould baffle 4 pressing system comprises a slide bearing and a funnel guide attached at the top in the blank mould, which guide the piston with pressing element axially to the blank mould profile before the pressing element immerses into the blank mould profile.

11. A method for producing a parison using the blank mould baffle pressing system according to claim 1, wherein
a) preferably from a feeder-a glass gob is loaded from above into a blank mould, and
b) a plunger tool is positioned in a loading position as a falling limit for loading the glass gob at the lower end of the blank mould,
c) the blank mould baffle pressing system performs a vertical closing movement by being moved from above into the blank mould until a stop on the blank mould baffle pressing system reaches a stop surface on the blank mould, whereby the piston is initially not subjected to gas pressure, but then shortly before or when reaching the stop surface is subjected to gas pressure and is thus pressed down to the stop surface, whereby the pressing element is in pressing position, and whereby a compensation for mass fluctuations of the glass gob is achieved via a control or closed-loop-control of the piston stroke, by adapting this stroke to the respective glass gob mass,
d) during the vertical closing movement of the blank mould baffle pressing system, the plunger tool is furthermore pressed against the parison forming in the blank mould upwards against the pressing element in pressing position, until the plunger tool with its plunger surface stops against a guidering surface, against which it is pressed until the pressing process is completed, and
e) after completion of the pressing process, a demoulding takes place, whereby the plunger tool is moved vertically downwards and the blank mould baffle pressing system is driven out vertically upwards and the blank mould is opened, whereupon a handover to a final shaping station can take place, whereby
the blank mould baffle pressing system is cooled during the production of the parison by means of an internal cooling device of the blank mould baffle pressing system with a cooling medium, preferably compressed air.

12. The method according to claim 11 for producing a parison using the blank mould baffle pressing system wherein the internal cooling device for cooling has a means that specifically distributes the cooling medium on the inner surfaces of the pressing element, the cooling medium, preferably pressurized settle blow air from a glass machine, is specifically distributed for cooling on the inner surfaces of the pressing element.

13. The method according to claim 12 for producing a parison using a blank mould baffle pressing system wherein the blank mould baffle pressing system comprises springs which press the pressing element upwards against a preferably integrated stop surface and thus keep it in the loading position as long as the piston is not subjected with gas pressure, while the blank mould baffle pressing system performs a vertical closing movement by being lowered from above into the blank mould and as long as the piston is not yet subjected to gas pressure, the piston is pressed vertically upwards against a preferably integrated stop surface by means of the springs of the blank mould baffle pressing system and thus held in loading position.

14. The method according to claim 13 for producing a parison using a blank mould baffle pressing system wherein the blank mould baffle 4 pressing system comprises a slide bearing and a funnel guide attached at the top in the blank mould, which guide the piston with pressing element axially to the blank mould profile before the pressing element immerses into the blank mould profile, while the blank mould baffle pressing system performs a vertical closing movement by being lowered from above into the blank mould, the pressing element is axially aligned at the upper funnel guide and through the slide bearing before the lower guide diameter of the pressing element dips into the blank mould profile to prevent a pressing element edge from tilting with the blank mould profile.

15. The blank mould baffle pressing system for forming a burr-free mouth entry of a glass container to be produced according to claim 2, wherein the means for targeted distribution of the cooling medium on the inner surfaces of the pressing element has a cooling medium supply line for air for settle blowing of a glass machine as compressed air for cooling in the piston.

16. The blank mould baffle pressing system for forming a burr-free mouth entry of a glass container to be produced according to claim 2, wherein the means for targeted distribution of the cooling medium on the inner surfaces of the pressing element has a cooling tube arranged in the piston.

17. The blank mould baffle pressing system for forming a burr-free mouth entry of a glass container to be produced according to claim 3, wherein the means for targeted distribution of the cooling medium on the inner surfaces of the pressing element has a cooling tube arranged in the piston.

18. The blank mould baffle pressing system for forming a burr-free mouth entry of a glass container to be produced according to claim 4, wherein the cooling medium is separated from the working area of the piston by a seal package inserted at the cooling medium supply line.
